(19) United States
(12) Patent Application Publication
(10) Pub. No.: US 2013/0154345 A1
(43) Pub. Date: Jun. 20, 2013

(54) Vehicle comprising a crawler track assembly

(71) Applicant: CLAAS SELBSTFAHRENDE ERNTEMASCHINEN GMBH, Harsewinkel (DE)

(72) Inventors: Waldemar Schulz, Osnabrueck (DE); Sebastian Wagemann, Oelde (DE); Jan Philipp Behra, Guetersloh (DE); Robert Obermeier-Hartmann, Bueren (DE); Sascha Rackow, Paderborn (DE); Philipp Muemken, Stuttgart (DE)

(73) Assignee: CLAAS SELBSTFAHRENDE ERNTEMASCHINEN GMBH, Harsewinkel (DE)

(21) Appl. No.: 13/626,073

(22) Filed: Sep. 25, 2012

(30) Foreign Application Priority Data
Sep. 29, 2011 (DE) 10201114536.6

(51) Int. Cl. B62D 55/14

(52) U.S. Cl. CPC B62D 55/14
USPC 305/129

(57) ABSTRACT

An agricultural vehicle includes comprises a crawler track assembly having a plurality of supporting rollers arranged one behind the other in the direction of travel of the vehicle and around which a belt is wrapped. The rollers are adjusted by way of an actuator between a first configuration, in which all supporting rollers are loaded, and a second configuration, in which at least one outer roller of the supporting rollers is relieved. An energy accumulator is charged by a drive energy source and connected to the actuator in order to provide the actuator with the drive energy required to adjust the configuration.

### CROSS-REFERENCE TO A RELATED APPLICATION

The invention described and claimed hereinbelow is also described in German Patent Application DE 10 2011 114 536.6 filed on Sep. 29, 2011. This German Patent Application, subject matter of which is incorporated herein by reference, provides the basis for a claim of priority of invention under 35 U.S.C. 119(a)-(d).

### BACKGROUND OF THE INVENTION

The invention relates an agricultural vehicle such as a tractor, a combine harvester, a forage harvester, a lifter or the like, with at least one crawler track assembly comprising a plurality of supporting rollers arranged one behind the other in the direction of travel of the vehicle and around which a belt is wrapped and configured so that the weight of the vehicle upon which the at least one crawler tack assembly is disposed is distributed over a large ground contact area and compression that is harmful to the ground, even where the weight of the vehicle is great, is at least largely prevented.

One known problem with the use of crawler track assemblies, however, is the limited maneuverability thereof. A crawler track assembly can change directions only if the belt can slide transversely to the rolling direction thereof at the front end and back end of the ground contact area. During travel on unyielding ground such as an asphalt road, the belt is therefore subjected to high shear forces during travel around curves, which high shear forces result in extensive wear. During travel on yielding ground such as agricultural acreage, the belt can carry parts of the ground being traveled over in the lateral direction during travel around curves, and therefore the load on the belt is lesser in this case. However, the shearing motion of the ground that results instead can cause damage there, for example, by associated destruction of the root system, for example sod.

Moreover, the forces required at the steered axle to steer a vehicle comprising a crawler track assembly are known to be provided in practical application by power-assisted steering. Therefore, if the drive energy source of the vehicle fails and the vehicle must be towed, it is extremely difficult to steer and requirements regarding the steering force that the driver must exert are very difficult to fulfill. While steering without a drive energy source in the case of a vehicle having an unsteered crawler track assembly and a steered wheel axle requires exertion by the driver that is considerable but is not fully ruled out, the steering of a crawler track assembly under the same circumstances exceeds the forces that any driver can apply. Therefore, in order to bring such a vehicle to a workshop if it breaks down, it must be loaded onto a hauling vehicle, which results in significant additional costs to the user.

Document DE 203 17 076 U1 discloses a known agricultural vehicle comprising a crawler track assembly. The known crawler track assembly includes supporting rollers configured as two large-size guide rollers and, therebetween, a plurality of smaller track-supporting rollers. The track-supporting rollers are moved vertically with the aid of an actuator and can form a configuration in which they relieve the guide rollers. As a result, the ground contact area is shortened considerably and the maneuverability of the crawler track assembly is improved. By adjusting the track-supporting rollers, it is therefore possible to reduce the wear of the belt during street travel or the shearing of the ground when maneuvering on an agricultural surface. However, the problem of poor maneuverability still exists in the case of trouble (i.e., if the drive energy source of the vehicle fails) since the track-supporting rollers can no longer be adjusted if the drive energy source fails.

### SUMMARY OF THE INVENTION

The present invention overcomes the shortcomings of known arts, such as those mentioned above.

The present invention provides a vehicle with a crawler track assembly that remains maneuverable even if a problem occurs, i.e., if the drive energy source thereof should fail.

In one embodiment, the invention provides an agricultural vehicle comprising at least one crawler track assembly having a plurality of supporting rollers arranged one behind the other in the direction of travel of the vehicle and around which a belt is wrapped. The rollers are adjusted by way of at least one actuator between a first configuration, in which all supporting rollers are loaded, and a second configuration, in which at least one outer roller of the supporting rollers is relieved. A drive energy source delivers drive energy required to adjust the configuration. An energy accumulator is charged by the drive energy source and connected to the actuator in order to provide the actuator with the drive energy required to adjust the configuration.

The actuator engages in an inner roller of the supporting rollers in order to press it downward, in a manner known per se, relative to a traveling-gear carriage of the crawler track assembly and the outer rollers suspended thereon, thereby lifting the traveling-gear carriage, including the outer rollers. The actuator also can act on the outer rollers in order to lift them relative to the traveling-gear carriage and the at least one inner roller.

Advantageously, the drive energy source is a source for a working fluid, which is under overpressure, and the energy accumulator is a first pressure reservoir, which is capable of receiving a certain quantity of said working fluid.

The actuator can also be connectable to a second pressure reservoir, the operating pressure of which is lower than that of the first pressure reservoir, in order to permit spring motion of the supporting roller upon which the actuator acts by displacing fluid between the actuator and the second pressure reservoir.

A directional control valve is advantageously provided in order to connect the actuator either to the first pressure reservoir or the second pressure reservoir. Provided the actuator is connected to the second pressure reservoir, spring motion of the supporting roller is possible. If the actuator is connected to the first pressure reservoir, however, the actuator assumes the second configuration having a shortened ground contact area.

If the directional control valve comprises a control input connected to the drive energy source, the directional control valve can automatically establish the connection to the first pressure reservoir if a problem occurs with the drive energy source that results in the loss of overpressure of the working fluid, thereby inducing the transition to the second configuration.

A control unit of the vehicle is provided in order to automatically implement the first configuration of the crawler track assembly during straight-ahead travel and automatically implement the second configuration of the crawler track assembly during travel around a curve. This is useful in particular during travel on an agricultural surface since, during straight-ahead travel, the weight of the vehicle is distributed over a large ground contact area, while, during travel around a curve, the shortening of the ground contact area in the second configuration reduces the shearing of the ground.

Furthermore, the control unit can be set up to implement the first configuration of the crawler track assembly below a limit speed and to implement the second configuration of the crawler track assembly above the limit speed, and therefore the second configuration, which protects the crawler track assembly, is automatically implemented during rapid travel on a road.

As a result of the automatic shortening of the ground contact area that takes place if the drive energy source fails, the force that the vehicle exerts against a change in direction is considerably less than if the running gear remains in the first configuration. A crawler track assembly that automatically transitions into the second configuration when the drive assembly fails also can be connected to the body of the vehicle in a manner that is steerable, i.e. pivotable about a vertical axis, without this possibly affecting the maneuverability of the vehicle when towed.

The control unit also can be set up to estimate the slip of the vehicle and, if the slip is above a limit value, implement the first configuration of the crawler track assembly and, if the slip is below the limit value, implement the second configuration of the crawler track assembly. Therefore, if the slip is too great, for example, during travel on yielding topsoil, the traction of the vehicle is improved by transitioning into the second configuration, while, if the slip is moderate, for example, during travel on a hard road, the first configuration is used to permit rapid travel while protecting the belts.

### BRIEF DESCRIPTION OF THE DRAWINGS

Further features and advantages of the invention will become apparent from the description of embodiments that follows, with reference to the attached figures, wherein:

FIG. 1 presents a schematic view of an agricultural vehicle according to the invention, in normal operation;

FIG. 2 presents a side view of the vehicle in which the drive assembly has failed;

FIG. 3 presents a view according to a second embodiment, which is analogous to FIG. 2;

FIG. 4 presents a view according to a third embodiment, which is analogous to FIG. 2; and

FIG. 5 presents a schematic depiction of a hydraulic system for adjusting the carrier wheels on the vehicles depicted in FIGS. 1 to 4.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

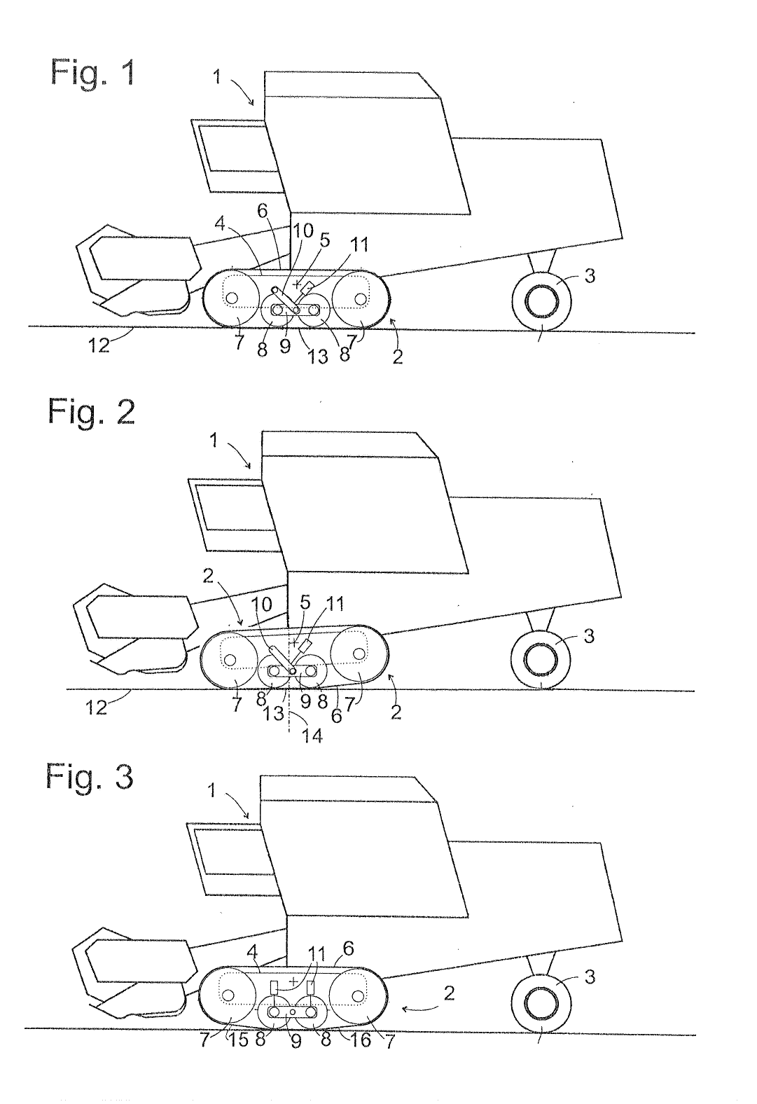

The vehicle shown in a schematic side view in FIG. 1 is a combine harvester, although the principles of the invention explained in the following also can be transferred and applied to other types of agricultural vehicles such as tractors, forage harvesters, lifters or the like.

The ground drive of the combine harvester in FIG. 1 comprises a crawler track assembly 2, which carries the major portion of the weight of the combine harvester 1, and a rear axle having rear wheels 3 with tires. The rear wheels 3 are steerable, while the two track roller units of the crawler track assembly 2 are fixedly oriented in the longitudinal direction of the combine harvester 1. Each of the track roller units mounted on the right and left of the body of the combine harvester 1 comprises a traveling-gear carriage 4, which is hinge-mounted to the combine harvester body such that it can pivot about an axis 5 that extends in the transverse direction of the combine harvester body. Guide rollers 7, around which a belt 6 is wrapped, are mounted on the traveling-gear carriage 4. One of the guide rollers 7 is driven by a drive energy source of the combine harvester. The drive energy source comprises, in a manner that is typical and familiar to a person skilled in the art, a diesel engine, which is not depicted in the figure, and a transmission for transferring torque from the diesel engine to the guide roller 7. A plurality of track-supporting rollers 8, specifically two in this case, is disposed between the guide rollers 7. A common carrier 9 of the track-supporting rollers 8 is hinge-mounted to the traveling-gear carriage 4 by way of a rocker arm 10. A pressure cylinder 11, which acts on the rocker arm 10 and on the traveling-gear carriage 4, holds the track-supporting rollers 8 pressed elastically against the ground 12. The elastic deflectability of the pressure cylinder 11 and the fact that the carrier 9 is pivotably connected to the rocker arm 10 make it possible for the track-supporting rollers 8 to move out of the way of any irregularities of the ground 12 and thereby maintain a uniform distribution of the weight of the combine harvester on the entire ground contact area 13 of the ground drive along a length corresponding to the wheelbase of the guide rollers 7.

FIG. 2 shows the same combine harvester as in FIG. 1, although with a different configuration of the rollers 7, 8 on the crawler track assembly 2. The pressure on the pressure cylinder 11 is increased in this configuration, and so the pressure cylinder 11 extends outwardly against the weight of the combine harvester loading proportionally thereon and swivels the rocker arm 10 in the clockwise direction, and so the carrier 9, including the track-supporting rollers 8, is pressed downward away from the traveling-gear carriage 4. The rear guide roller 7 is therefore lifted off the ground 12 and the ground contact area 13 is shortened to the distance between the axle of the front guide roller 7 and the axle of the rear track-supporting roller 8. Since the weight of the combine harvester body rests on the crawler track assembly 2 over the axis 5 extending between the two track-supporting rollers 8, said track-supporting rollers now carry a greater portion of the weight of the combine harvester 1 than the front guide roller 7, which still touches the ground 12.

Therefore, when the combine harvester 1 is steered into a curve by turning the rear wheels 3, only moderate friction forces occur in the front region of the ground contact area 13 between the front guide roller 7 and the front support roller 8. An instantaneous axis of rotation 14 of the rotational motion of the belt 6 relative to the ground 12 during travel around the curve is located between the two track-supporting rollers 8, and therefore the slip of the belt 6 in the transverse direction is low where the two track-supporting rollers 8 bear thereon and where the friction forces are therefore great. The substantially greater slip at the front guide roller 7 places only minimal strain on the belt 6 since the load carried by said guide roller 7 is low. Therefore, a relatively low steering force at the rear wheels 3 is sufficient to turn the combine harvester 1 into a curve, which can even be applied manually by the driver, if necessary, without support from a servomechanism.

FIG. 3 shows a modified embodiment of the combine harvester 1, in which the carrier 9 of the track-supporting rollers 8 can be displaced parallel relative to the traveling-gear carriage 4 and the guide rollers 7, in this case with the aid of two pressure cylinders 11 operated in parallel. Such a design makes it possible to lift both guide rollers 7 off the ground 12 by pressing the carrier 9 downward, thereby shortening the ground contact area to the wheelbase of the track-supporting rollers 8. It is therefore possible to fully prevent the belt 6 from slipping on the ground transversely to the direction of travel in the sections 15, 16 thereof extending in front of and behind the track-supporting rollers 8.

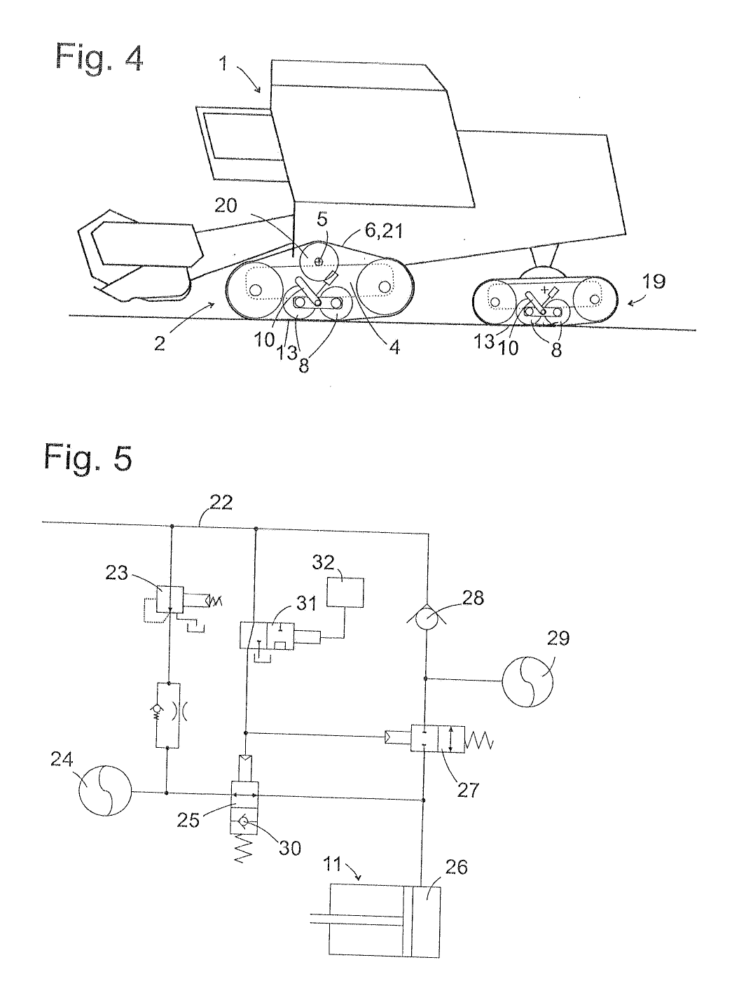

FIG. 4 shows a combine harvester 1 comprising front and rear crawler track assemblies 2, 19. The front crawler track assembly 2 is of the stacked type, comprising a driven roller 20, which is disposed above the track-supporting rollers 8 and acts on an upper strand 21 of the belt 6, and the rotational axis of which is simultaneously the pivot axis 5 of the traveling-gear carriage 4 relative to the combine harvester body. The rear crawler track assembly 19 carries a smaller portion of the weight of the combine harvester 1 than the front crawler track assembly 2, and is therefore smaller. Both crawler track assemblies 2, 19 comprise track-supporting rollers 8, which are hinge-mounted on the traveling-gear carriages thereof by way of a rocker arm 10, said track-supporting rollers being shown in the figure in the downwardly extended position, in which only one of the guide rollers 7 has contact with the ground 12. The short ground contact surface 13, more particularly of the rear crawler track assembly 19, makes it possible in this case as well to steer without power assistance.

FIG. 5 schematically shows a hydraulic system for adjusting the track-supporting rollers 8. A high-pressure line 22 is connected to a pressure pump (not depicted) of the drive energy source. Provided the drive energy source operates properly, the pressure at the high-pressure line 22 can be typically 180 bar, for example. A pressure reducer 23 having an outlet pressure of 100 bar, for example, is connected to the high-pressure line 22 and supplies a pressure reservoir 24. In the normal straight-ahead travel mode, as shown in the figure, a first directional control valve 25 is located in a position that is passable in two directions and therefore connects the pressure reservoir 24 to a working chamber 26 of the pressure cylinder 11. In said position, the pressure cylinder 11 can yield in a resilient manner by way of displacement of hydraulic fluid from the working chamber 26 into the pressure reservoir 24 when the track-supporting rollers 8 pass over a raised area of the ground, or extend, driven by hydraulic fluid from the pressure reservoir 24, when the track-supporting rollers pass over a sunken area. A second directional control valve 27 is disposed between the working chamber 26 and a second pressure reservoir 29, which is held at the pressure of the high-pressure line 22 by way of a non-return valve 28. Said directional control valve 27 blocks during normal straight-ahead travel.

If a problem occurs with the drive assembly, the pressure on the high-pressure line 22 collapses and the two directional control valves 25, 27, which comprise control inputs connected to the high-pressure line 22, change their state. The first directional control valve 25 now switches a non-return valve 30 between the working chamber 26 and the first pressure reservoir 24. The orientation of the non-return valve 30 is selected such that the working chamber 26 can accept a higher pressure than the pressure reservoir 24. At the same time, the directional control valve 27 opens and applies the high pressure to the working chamber 26 that was maintained in the pressure chamber 29. As a result, the pressure cylinder 11 extends and the track-supporting rollers 8 controlled thereby assume the configuration shown in FIG. 2, 3 or 4. It is thereby ensured that the combine harvester 1 can be steered even if the drive assembly fails, thereby enabling it to be towed and to be steered by a towing vehicle.

According to a development, a third directional control valve 31 is disposed between the high pressure line 22 and the control inputs of the directional control valves 25, 27. The directional control valve 31 can be actuated mechanically, for example, by coupling to a control stick of the combine harvester 1, or electrically, for example by way of an electronic control unit 32 coupled to the steering of the combine harvester. During straight-ahead travel, the directional control valve 31 is located in the position shown in FIG. 5. During travel around a curve, it assumes a second position in which it depressurizes the control inputs. In every curve, the crawler track assembly therefore automatically transitions into a raised configuration according to one of the FIGS. 2 to 4, and the shearing of the ground is reduced.

The control unit 32 also can operate to activate the directional control valve 31 depending on the speed of the combine harvester 1, thereby ensuring that the crawler track assembly 2 and/or 19 transitions into the raised configuration as soon as the combine harvester exceeds a limit speed, which is typically not reached in field work. The belt 6 is therefore protected during travel on the road without intervention by the driver.

A third possibility for automatically adjusting the configuration of the crawler track assembly 2 and/or 19 is based on the estimation of the slip of the vehicle by the control unit 32. Provided that, during travel in the raised second configuration, the rotational speed of the rollers of all crawler track assemblies 2, 19 and, possibly, wheels 3, does not deviate from the values expected in light of the ground speed and track radius of the vehicle by more than a predefined first limit value, the slip of the vehicle is low. When the limit value is exceeded, the control unit 32 increases the traction by transitioning into the first configuration. In the first configuration, a second limit value of the slip is defined, which, if fallen below, triggers a return to the second configuration. The control unit therefore automatically switches to the first configuration on yielding, slippery ground, and automatically switches to the second configuration on solid ground.

The following list of reference signs of various elements mentioned above is included (as follows), for ease of explanation:

### Reference Characters

1 combine harvester
2 crawler track assembly
3 rear wheel
4 traveling-gear carriage
5 axis
6 belt
7 guide roller
8 track-supporting roller
9 carrier
10 rocker arm
11 pressure cylinder
12 ground
13 ground contact area
14 instantaneous axis of rotation
15 section
16 section
19 crawler track assembly
20 driven roller
21 strand
22 high pressure line
23 pressure reducer
24 pressure reservoir
25 directional control valve
26 working chamber
27 directional control valve
28 non-return valve
29 pressure reservoir
30 non-return valve
31 directional control valve
32 control unit

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. An agricultural vehicle (1) comprising:
at least one crawler track assembly (2; 19) having a plurality of supporting rollers (7, 8) arranged one behind the other in the direction of travel of the vehicle and around which a belt (6) is wrapped, wherein the rollers (7, 8) are adjusted by way of at least one actuator (11) between a first configuration, in which all supporting rollers (7, 8) are loaded, and a second configuration, in which at least one outer roller (7) of the supporting rollers (7, 8) is relieved, and
a drive energy source for delivering drive energy required to adjust the configuration, wherein an energy accumulator (29) is charged by the drive energy source and connected to the actuator (11) in order to provide the actuator (11) with the drive energy required to adjust the configuration.

2. The vehicle according to claim 1, wherein the actuator (11) acts on an inner roller (8) of the supporting rollers (7, 8).

3. The vehicle according to claim 1, wherein the drive energy source is a source for a working fluid, which is under overpressure, and the energy accumulator (29) is a first pressure reservoir.

4. The vehicle according to claim 3, wherein the actuator (11) is connected to a second pressure reservoir (24), an operating pressure of which second pressure reservoir (24), is lower than an operating pressure of the first pressure reservoir (29), in order to permit spring motion of the supporting roller (8) upon which the actuator (11) acts.

5. The vehicle according to claim 4, wherein at least one directional control valve (25; 27) connects the actuator (11) either to the first or the second pressure reservoir (29; 24).

6. The vehicle according to claim 5, wherein the directional control valve (25; 27) comprises a control inlet, which is connected (22) to the drive assembly.

7. The vehicle according to claim 1, further comprising a control unit (32), which is set up to implement the first configuration of the crawler track assembly (2; 19) during straight-ahead travel, and to implement the second configuration thereof during travel around a curve.

8. The vehicle according to claim 1, further comprising a control unit (32), which is set up to implement the first configuration of the crawler track assembly (2; 19) below a limit speed, and to implement the second configuration thereof above the limit speed.

9. The vehicle according to claim 1, further comprising a control unit (32), which is set up to estimate a slip of the vehicle and, if slip is above a limit value, implement the first configuration of the crawler track assembly (2; 19) and, if slip is below the limit value, implement the second configuration thereof.

10. The vehicle according to claim 1, wherein the crawler track assembly (19) is steerable.
